(19) United States
(12) Patent Application Publication
(10) Pub. No.: US 2017/0250646 A1
(43) Pub. Date: Aug. 31, 2017

(54) POWER GENERATING INSTALLATION AND STRUCTURE THEREOF

(71) Applicant: SOLOGIC SYSTEM LTD., BINYAMINA (IL)

(72) Inventors: Michael Lasry, Binyamina (IL); Yoav Ben Dov, Tel Aviv (IL)

(21) Appl. No.: 15/054,442

(22) Filed: Feb. 26, 2016

(51) Int. Cl. H02S 20/10; A41G 1/00

(52) U.S. Cl. CPC H02S 20/10; A41G 1/007

(57) ABSTRACT

A structure for a power generating installation includes sub-division branching's coupled together to form the structure. At least some of the uppermost branching's are attached to solar panels.

### TECHNICAL FIELD

Embodiments of the invention relate to a power generating installation and structure thereof and in particular to such a structure having successive branchings and/or subdivisions.

### BACKGROUND

Power generating installations may be of a type capable of utilizing available renewable energy sources from the surrounding biosphere. One example of such available energy may be sunlight that can be used to create solar power by solar panels converting sunlight into electricity.

Power generating installations may be of an autonomous type configured for creating substantially all their power without conventional electrical grid access. Other configurations may be of types having access to the grid for, energy receipt from and/or transmission to, the grid.

Centralized large-scale photovoltaic power stations are typically designed for the supply of power into the electrical grid, while decentralized power applications, such as building-mounted panels, may be used for the supply of power to a local user or users.

Solar panels are typically supported in place by racks or frames when for example placed on a roof top, however placing solar panels in proximity to a human environment such as in an urban pedestrian environment may require more complex structures for supporting the panels that aesthetically blend into the environment.

### SUMMARY

The following embodiments and aspects thereof are described and illustrated in conjunction with systems, tools and methods which are meant to be exemplary and illustrative, not limiting in scope.

In a embodiment there is provided a structure for a power generating installation comprising sub-division branching's coupled together to form the structure, wherein at least some of the uppermost branching's are attached to solar panels. Preferably the structure has a “tree-like” shape and the branching's resemble tree branches.

Possibly, coupling between at least two upper and lower branching's is formed by providing the upper branching with a coupling region at its lower end and the lower branching with at least one opening through its periphery for receiving the coupling region.

Possibly, the at least one opening through the periphery of the lower branching comprises two openings and the coupling region is received through a first one of the openings and projects out of the second opening.

Typically, sub-division branching's coupled to each other extend transversely one in relation to the other. This in a preferred embodiment resembles the manner in which tree branches extend transverse one to the other stemming upwards one out of the other.

In accordance with an embodiment of the present inventions there is also provided a method of forming a power generating installation comprising the steps of: providing a plurality of sub-division branching's, coupling between the branching's to form an ascending structure, and attaching uppers sides of at least some of the upper most branching's to solar panels.

Possibly, coupling between adjacent branching's permits at least some movement between the coupled branching's. This may permit assembly, preferably on site, of an embodiment of the structure that may first be firmly attached to the solar pales and only after that firmly fixed so that final adjustment between parts (sub-divisions) of the structure occurs at the couplings between the parts, while the areas of the structure attaching to the solar panels are able to assume their accurate positions where they are designed to attach to the panels.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIGS. 1A to 1F schematically show an embodiment of a power generating installation of the present invention including a structure supporting solar panels;

FIG. 2A and 2B schematically show exploded and non-exploded views of successive branchings and/or subdivisions of an embodiment of a structure for supporting solar panels in a power generating installation;

FIG. 3 schematically show a cross section along line III-III in FIG. 2B; and

FIG. 4 schematically shows a cross section along line IV-IV in FIG. 2B.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

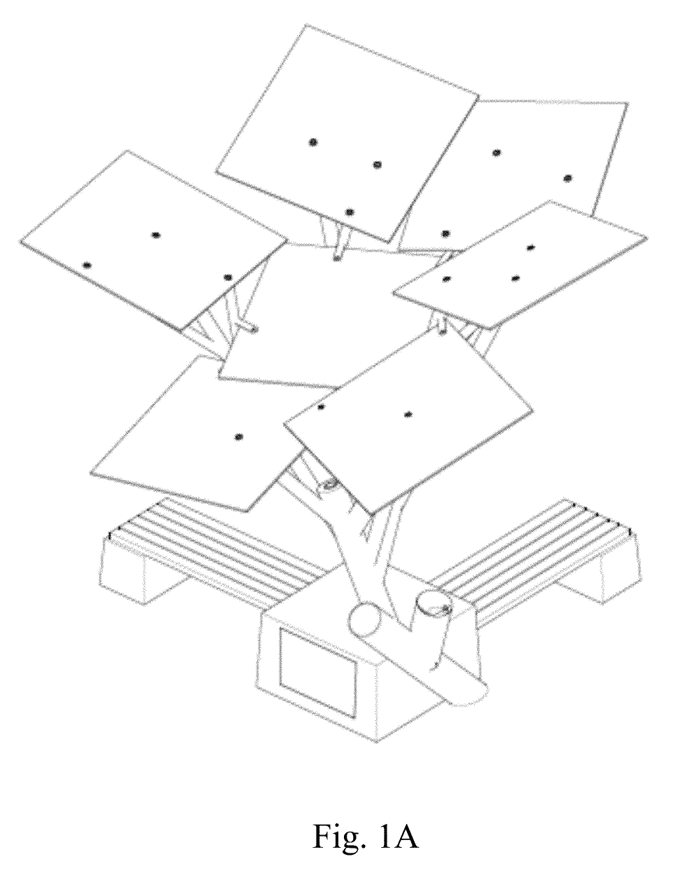

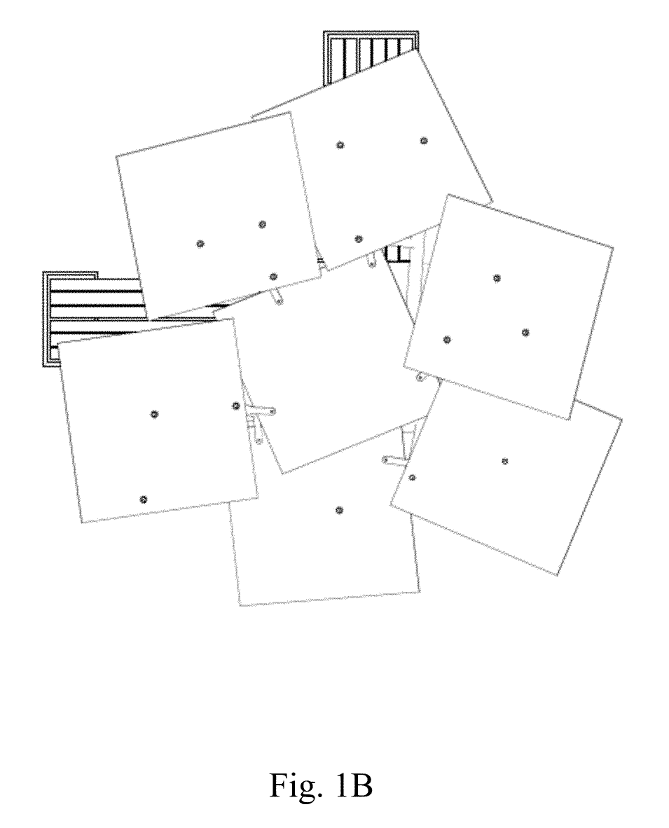

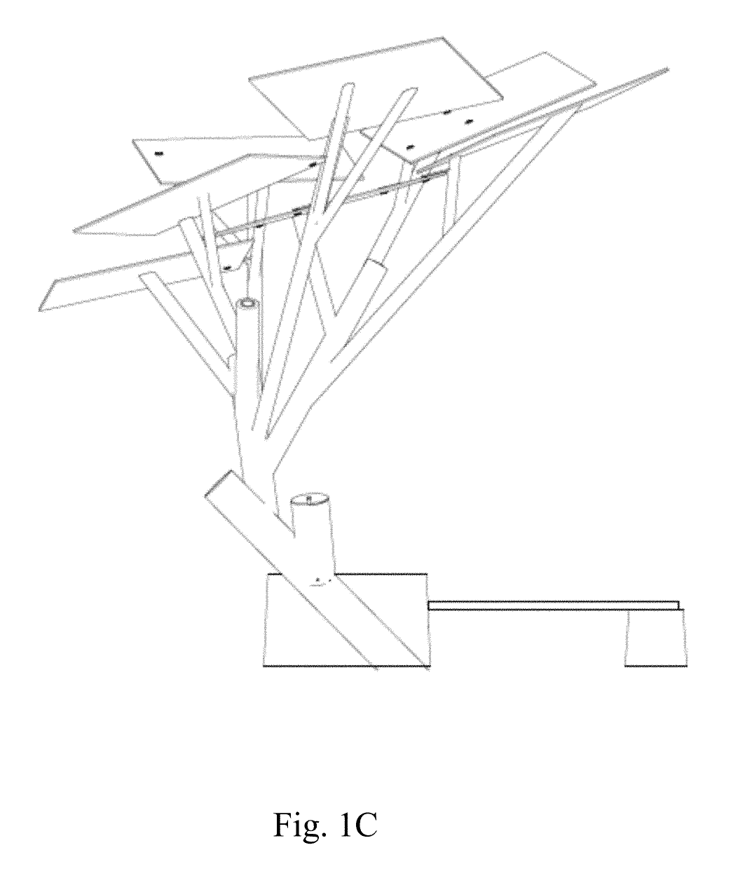

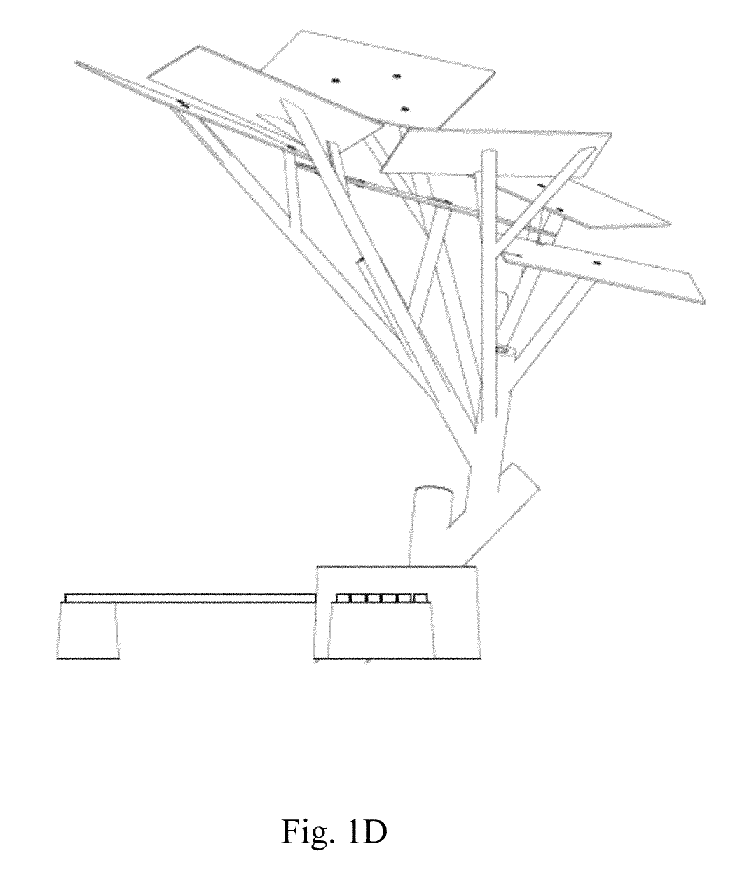

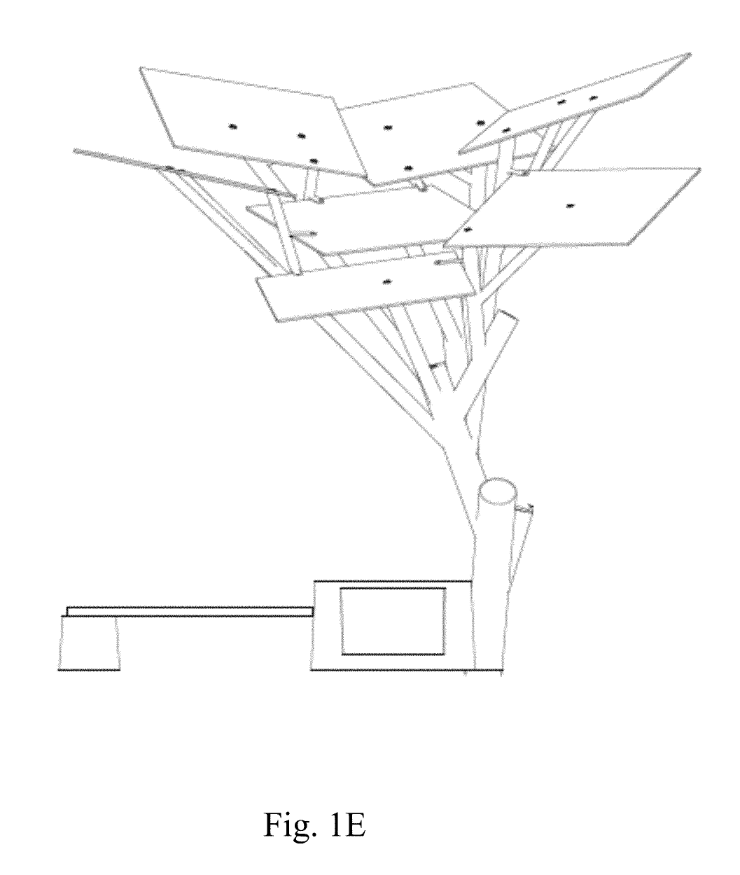

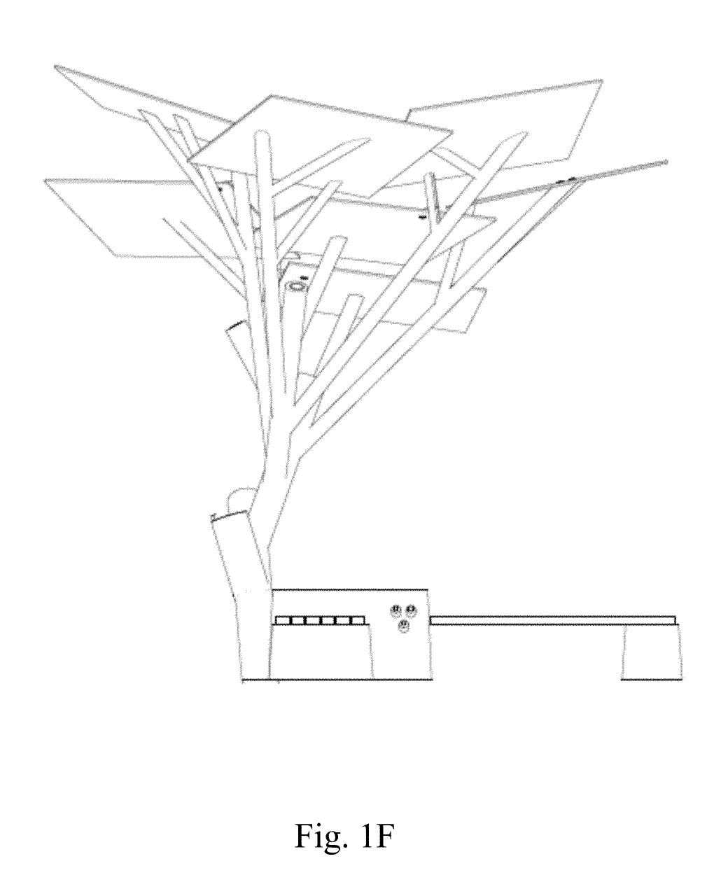

Attention is first drawn to FIGS. 1A to 1F showing an embodiment of a power generating installation of the present invention. Here, the installation includes a structure illustrated as a tree-like configuration suitable for blending into a human environment, such as an urban and/or recreational environment (or the like). The structure includes successive branching's and/or subdivisions leading up from a trunk sub-division of the tree to upper branching's that support upper leaf-like solar panels.

Adjacent the trunk, the installation includes a cubic base and benches extending away from the base. The base may house instruments/devices that may be useful for the function of the installation, such as a battery for storing electrical power generated by the solar panels, a Wi-Fi device for providing wireless Internet and network connections for users located adjacent the installation, USB connections for such users, (etc.).

FIG. 1A is a perspective front and right-side view of the installation, FIG. 1B is a top view of the installation, FIG. 1C is a right-side view of the installation, FIG. 1D is a left-side view of the installation, FIG. 1E is front view of the installation, and FIG. 1F is rear view of the installation.

Structures for supporting solar panels are typically configured to include attachment means (such as connectors/fasteners/apertures) for attaching to the solar panels, while the panels in turn are designed to include respective anchoring areas for receiving and/or connecting to the attachment means. Such anchoring areas may be designed in some cases to be absent of solar cells. Therefore, it is desirable that the structure for supporting the solar panels in the installation be accurately positioned in ‘space’ so that the attachment means correctly meet the panels in the respective anchoring areas.

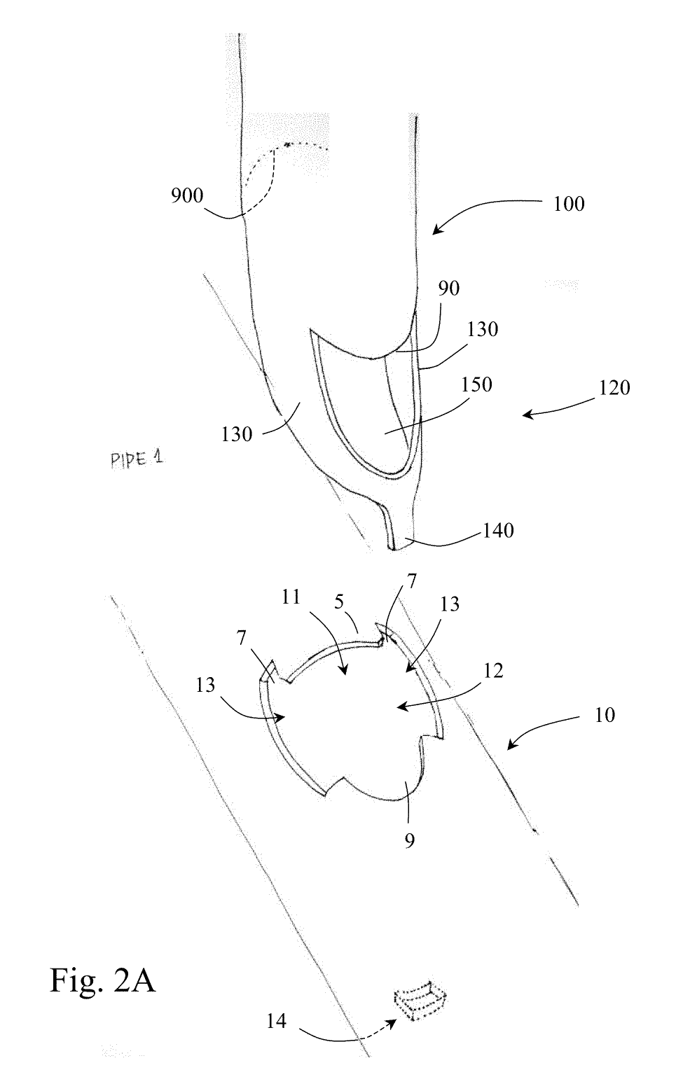

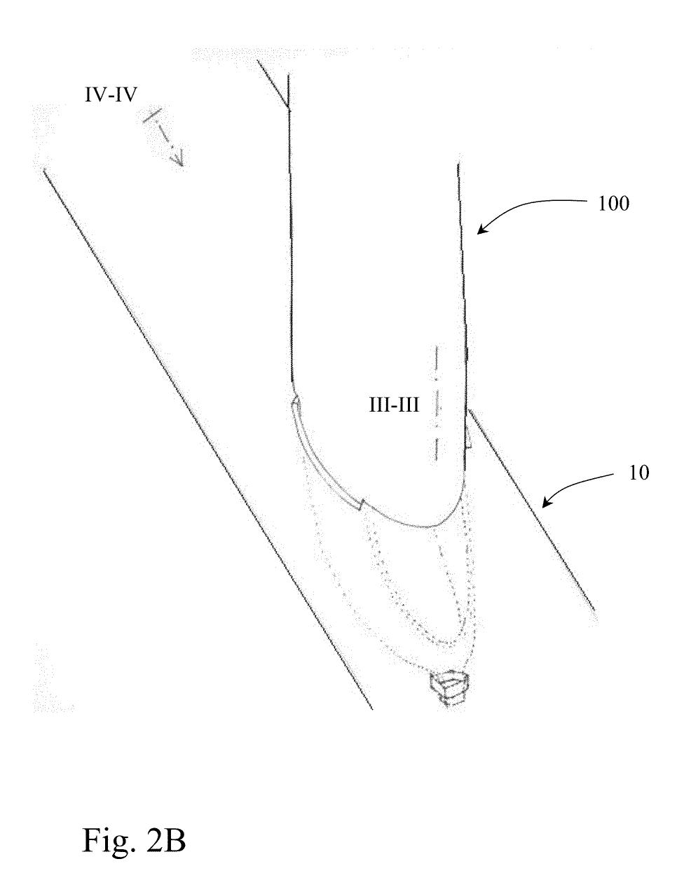

Attention is drawn to FIGS. 2A and 2B showing respective exploded and non-exploded views of branching's and/or subdivisions of an embodiment of a structure for supporting solar panels. Branching 10 may be a lower part of the structure such as a trunk-like subdivision of the “tree” shaped structure and branching 100 may be a more upper subdivision of the structure.

In an embodiment, branching 10 is formed in its periphery with opposing first and second openings 12, 14. First opening 12 is larger than the second opening 14 and includes a main section 11 and two wing-like minor sections 13 located on both sides of section 11 and in communication therewith. Main section 11 has a lower portion 9 extending below the lower ends of the minor sections 13 and each one of the minor sections 13 includes an upper portion 7 extending above an upper end of main section 11. A bridge 5 formed along an upper end of main section 11 on a periphery of branching 10 is located between the upper portions 7. Second opening 14 is located lower than the first opening 12 and is possibly rectangular shaped.

Branching 100 includes a lower coupling portion 120 configured to interact with the first and second openings 12, 14 in branching 10 for coupling between the branching's—here 10, 100. Coupling portion 120 has a lower tip 140 and an aperture 150 forming two arms 130 extending on both sides of aperture 150 down to tip 140. An upper part of aperture 150 forms a first lip 90 bridging between the upper sides of the arms 130. Coupling 120 includes in addition a second lip 900 formed on a periphery of branching 100 opposite to where aperture 150 is located. Second lip 900 also bridges between the upper sides of the arms 130 from an opposing direction to the first lip 90. The first and second lips 90, 900 are arc shaped and are separated by the arms 130.

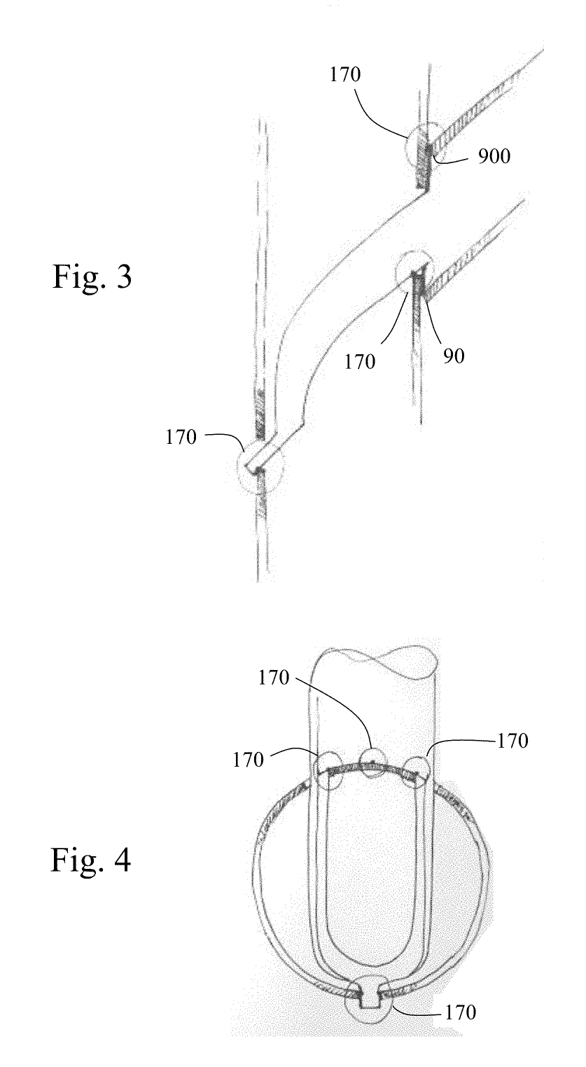

Assembly between two branching's (in this example 10, 100) may be accomplished by urging the coupling portion 120 of branching 100 into the first opening 12 of branching 10 with the tip 140 leading, until tip 140 is located within the second opening 14—possibly slightly projecting out of opening 14. In this position, each arm 130 is located within a respective one of the minor sections 13 with lip 90 abutting a periphery of branching 10 just below the lower portion 9 of main section 11 and possibly also with lip 900 abutting bridge 5. An assembled state of branching's 10, 100 can be seen in FIG. 2B and the cross sections of FIGS. 3 and 4.

As seen in the cross sections, assembly between the branching's 10, 100 possibly creates leaning/abutment regions 170 between the two coupled branches 10, 100—here four such regions being indicated. In this example, one region 170 may be located at a merge between tip 140 and second opening 14, two additional regions 170 may be located along a merge between second lip 900 and bridge 5 and one additional region 170 may be located along a merge between the first lip 90 and a periphery of branching 10 just below portion 9 of main section 11. The four regions 170 discussed above may be formed by slightly pushing branching 100 upwards after its coupling is located within branching 10.

Possibly, each two branching's after being coupled together may be welded together to firmly keep and secure them together. In one embodiment, welding between at least some of the branching's may be performed after substantially all branching's of the structure are in place with the upper most branching's being connected to at least some of the solar panels. Maintaining at least some of the couplings between branching's “loose” (i.e. not yet welded) may allow to accurately position in ‘space’ the attachment means so they correctly meet their respective anchoring areas in the solar panels, before firmly welding all remaining branching's together.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A structure for a power generating installation comprising sub-division branching's coupled together to form the structure, wherein at least some of the uppermost branching's are attached to solar panels.

2. The structure of claim 1, wherein coupling between at least two upper and lower branching's is formed by providing the upper branching with a coupling region at its lower end and the lower branching with at least one opening through its periphery for receiving the coupling region.

3. The structure of claim 2, wherein the at least one opening through the periphery of the lower branching comprises two openings and the coupling region is received through a first one of the openings and projects out of the second opening.

4. The structure of claim 1, wherein sub-division branching's coupled to each other extend transversely one in relation to the other.

5. The structure of claim 4, wherein sub-division branching's are coupled to each other in an ascending manner from a lower most branching extending up from a ground face to an upper most branching attached to a solar panel.

6. A method of forming a power generating installation comprising the steps of:
providing a plurality of sub-division branching's,
coupling between the branching's to form an ascending structure, and
attaching uppers sides of at least some of the upper most branching's to solar panels.

7. The method of claim 6, wherein adjacently coupled branching's extend transverse one in relation to the other.

8. The method of claim 6, wherein coupling between adjacent branching's permits at least some movement between the coupled branching's.

9. The method of claim 8, wherein at least some of the coupled branching's are permanently fixed to each to not permit such movement after the at least some of the upper most branching's are attached to the solar panels.

10. The method of claim 7, wherein coupling between adjacent branching's permits at least some movement between the coupled branching's.
